(19) United States
(12) Patent Application Publication
(10) Pub. No.: US 2004/0254815 A1
(43) Pub. Date: Dec. 16, 2004

(54) Error proof scheduling, filing, and tracking system for papanicolaou screening

(76) Inventor: Sumathi Paturu, Pleasant Grove, AL (US)

Correspondence Address: DR. SUMATHI PATURU, MD., 207, BROOKE-LYN TERRACE, PLEASANT GROVE, AL, 35127, US

(21) Appl. No.: 10/461,603

(22) Filed: Jun. 13, 2003

(51) Int. Cl. G06F 17/60

(52) U.S. Cl. 705/2

(57) ABSTRACT

Cancer screening is a very important aspect of practice management. How ever there is no efficient cancer tracking systems existent so far, though there is screening protocols devised by the American cancer society for most of the commonly occuring cancers. The cervical cancer scheduling, tracking and filing described here in, is the simplest, economical, and the most efficient cancer tracking system that can be practiced both in the urban and rural settings and in the small and large practices, and a very time saving system that can be confidently followed due to it's more than one independent and not interdependent back up devices.

The scheduling, filing and tracking system for Papanicolaou (PAP) screening, a method of female genital cancer screening system, is very important clinical aspect of practice management for both ob./gyns. and family practitioners. It is very easy to miss the abnormal PAP smears by misplaced charts in the clinic, or by not having patients with early cancer come in time to have PAP smears done. So it is very important to have in all the primary health care clinics, a pap smear monitoring system that should be complete, and literally error proof.

This is a PAP smear scheduling, filing, and tracking system written as an instructional manual, with the inclusion of a ‘file compilation’ section at the end of the text, that has tabs, file dividers, and tables, to help construct the file, which otherwise would be difficult for a busy practitioner, to initiate the filing.

Cervical Cancer

The ACS estimated that about 13,000 new cases of invasive Cervical cancer are diagnosed and 4100 deaths would occur from cervical cancer during 2002. The AAFP, ACOG, ACS and US and Canadian preventive task force recommend that all women receive screening PAP smears at the onset of sexual activity, or at 18 years of age—which ever is earlier. As for American Cancer Society, there is no upper limit for screening. However American College of preventive medicine recommends screening to be discontinued at age 65:

If the woman has been regularly screened,

If the woman has had 2 satisfactory smears and no abnormal smears in the previous 9 years,

If never screened, needs 3 consecutive satisfactory smears.

### Brief Description of the Filing and Tracking System

The filing system about to be described is very effective in taking care of every clinical aspect of PAP Screening done in the primary care clinics like:

1. Scheduling the whole patient pool every year for PAP Smear, even if they don't come by themselves.

2. Have all the reports documented in the same file.

3. Highlighting all the abnormal PAP Smears to follow up until definitive treatment is done.

4. Having an inbuilt and error proof Tracking system which implements itself without any extra effort from the clinic personnel.

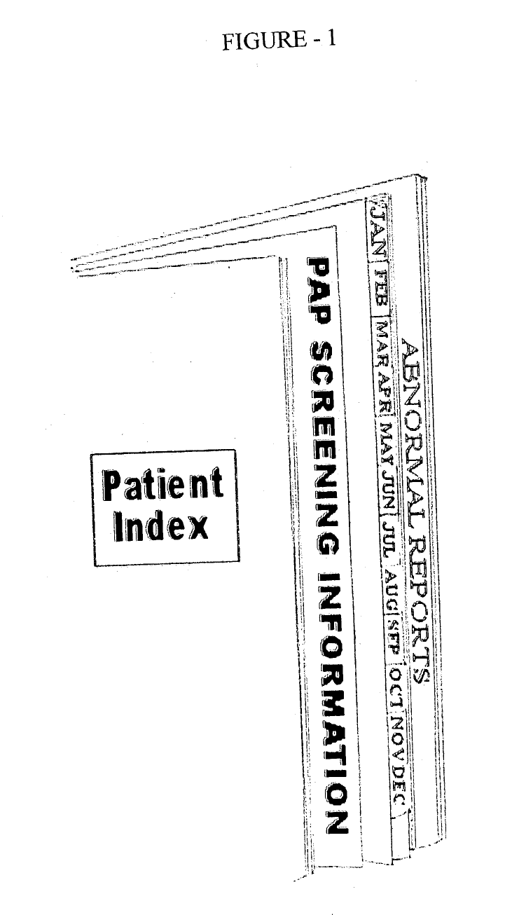

The PAP screening scheduling and tracking system I am about to describe is incredibly simple, which is it's best asset, that makes it suitable both for urban and rural clinics. It is strongly suggested that every body in the clinic along with the doctor read it, because implementing this filing has to be done as a team work. The system can be a great help to the Ob/gyns., who have unexpected emergencies daily, which can be drawn and prolonged, and the family practitioners who are over burdened with multitude of health maintenance issues which are not as easy as they seem. This PAP Smear logging system is divided mainly into three broad divisions. Look at the schematic model of the filing, FIG. 1, in the following pages, that shows all the three divisions of the file, as a schematic drawing.

1. PATIENT INDEX—It contains all the patients' names in the alphabetical listings A-Z, and indicates the page number, and location of their record in the filing, which also happens to be their most recent, or future appointment date. It helps to find the patient record in the file at any given period of time. See the table—1, that shows the typical patient index page, for the alphabetical group A.

2. PAP SCREENING INFORMATION—This section contains the actual patient records and is comprised of 12 months divisions, January-December, as shown in the FIG. 1, the ‘Schematic model of the file’. The record of the patients who ever had, or will have appointments in any month, stays in that corresponding month and the sections of the months and their page numbers have built in tracking system, that implements itself on an ongoing basis. One whole page is allotted to each patient, and it contains the ‘PAP screening information table’ (See table—2), which accommodates 8 years of PAP screening data and the rest of the patient information.

3. ABNORMAL REPORTS—This section contains only the names of the patients that have abnormal PAP smear reports, to be closely followed up until definitive treatment is done. See the table—3, ‘The abnormal reports’ that shows the information contained in the table.

After description of the filing and tracking system, there is a section for the components for the ‘file compilation’, which includes instructions and also the materials to be used to construct the file—like sectional headings, file dividers, tabs and tables to be used in the file. They are to be used as they are supplied, because many practitioners do not have time to make it as described, and the whole endeavor of this narration will not serve it's intended purpose, with out them.

### DETAILED DESCRIPTION OF THE FILING AND TRACKING SYSTEM

Patient Index

This is the first division of the file. See the table—1. It is a typical page of the Patient index. The patient index has names of all the patients, who ever had Pap smears done in the clinic, listed in an alphabetical order A-Z, one page allotted to each alphabet.

The ‘Patient Index’ page has a table divided into two columns that contain:

1) Patients' names and DOB

2) Location of Patients' records

The 2^{nd} column i.e. ‘Location of patients’ records is again divided into smaller columns to note down where the patient's cancer screening record is located in the file. More information about Patient index will be discussed later, when the relevance of the information can be better understood, than at present.

Pap Screening Information

The second division i.e. the PAP screening information division is made up of 12 months sections, January-December, divided by month tabs. Each month has records of patients whose PAP smears were done, or to be done, during that month. So during any month of the year the patients records that are there, are the patient population that are to be focused on. It has to be made sure that these patients keep up their appointments, or else they have to be rescheduled. The date of the month the patient has the clinic appointment is also the page number of that patient's record in that month. So on any current DATE, which also is the page number (like the calendar date) only the patient's records that have appointments that day are being dealt

[image]

With. And also unlike other files the pages of the patients' records in this file don't stay in the same place all the time. They are designed to move to the corresponding pages and month, each time the patient has reappointment.

The Pages of PAP Screening Information

Look at the typical page of the ‘PAP screening information’ division of the file that has Pap screening information table (table 2). In the PAP screening table, you document information every time patient has PAP smear done, and it is the reference source on any patient who ever had PAP smear done in your clinic. Each page is totally allotted to one patient. It accommodates 8 columns and documents all the 8 years information about PAP smears, for any given patient.

The PAP Screening Information Table

It has the patient's personal data on the top that includes patient's name, address, DOB and phone numbers. The table itself is divided into four vertical columns that are meant for—

1) PAP smear scheduling dates,

2) Date PAP smear done,

3) Pathology report, and

4) Results notified.

The columns of the table need further description.

Vertical Columns

1. Pap smear scheduling date—In this column, all the dates the patient is scheduled for screening, are documented. There is enough space to document 3-4 dates if the patient misses an appointment. So more dates in this column indicates non compliance, that needs to be

[image]

addressed. (R) can be put for refused appointments next to the date, if patient refuses to have PAP screening done when called to schedule, and (M) next to the date, if she misses the appointment.

2. Date PAP smear done—This is the second column, and is to document the date the PAP smear is done at any time. So there will be only one date in this column. (R) can be put for refused appointments, and (M) for missed appointments, and can also add ‘Not Done’ after it is finally confirmed that the patient is having the screening done, at least for that year. The table also includes other cancer screening procedures like cervical and endometrial biopsies.

3. Pathology report—The third column that is wider, is to note down the pathology report. All the abnormal reports have to be high lighted (Just key words like ‘Ascus’, ‘Invasive Cancer’, etc). This column should also include the definitive treatment undertaken for these abnormal reports.

4. Results notified—Some clinics call the patients about the results and some mail cards. Some may tell the patient that they will call if at all there is any abnormal report. It can be mentioned as per the usual practice that was effective for the clinic before. But the most important idea is to document the date that the patient is informed the about an abnormal report. The abnormal reports are also to be documented in ‘Abnormal Reports section’—to be described later.

How to Get Started, Along with Current Month's Scheduling

Refer to the FIG. 1, ‘The Schematic model of filing’, which can be followed to make the file. File dividers and the month tabs can be done as shown. As mentioned already there are some printed file dividers and tabs at the end of this text, which can be very helpful. All the patients' records should be logged into this file. If there is already some type of logging system in the clinic, the previous year's patient list of PAP screening can be obtained from that. If not, usually there must be at least some filing that contains all the names of the patients entered, before sending the PAP smears to the pathology lab. Each and every clinic has to maintain that in their lab. From this book, the list of the names of the patients from January-December can obtained.

The easy way to do it is to have loose sheets of PAP screening tables and enter the patients' personal information on the top, and the date of recent PAP smear in the first row of the ‘Date PAP Smear Done’ column (the second vertical column). One may or may not choose to write previous year's pathology report if it is normal, but it has to be mentioned, if it is abnormal.

This patient pool may not be the whole list of the eligible female population. It is important that all the female patients of the clinic be logged into the system to be tracked down every year for repeat PAP smear. The aim of the system is also to identify all non-complaint patients, educate them about the benefits of PAP smear in early diagnosis, and convince them to have PAP smears done. This is the only way to decrease the cancer mortality and morbidity. In the case of non-compliant patients, the physician who is identified as their family physician or ob./gyn., will still be held responsible for not doing the simple screening test, if the patient happens to be diagnosed with cancer at a later date.

So it is also important to generate a computer list of all the patients, which usually will be in an alphabetical order, with age and phone numbers listed.

As the PAP smear screening tables for the patients being picked up from the pathology logbook in the lab are being made, these patients' names should be checked off, from the computer-generated list. It should not be hard because of the computer list being in alphabetical order.

The listing in the lab would be in chronological order. Starting with the current month's filing and current PAP smears is beneficial and efficient, because that way the file starts to be functional from the beginning. The previous year's PAP smear date being entered into the first row of the ‘date PAP smear done’ column—is going to be the date the patient needs to be rescheduled again this month and year. These records have to be filed in this month. For now, these dates can be marked as page numbers also with a pencil, in the right upper corner of the page, with a pencil or an erasable pen. These names and the page numbers should also be entered into the patient index table.

The patients of the current month can be started, by calling, and scheduling while still preparing the file. That way as mentioned, the file starts to be functional also from the very beginning. These pages are filed in the same serial order as in the lab's logbook, and their page numbers also marked (and entered into the patient index table also) at the time of initially filing. Now to the previous PAP smear date, one extra day has to be added (insurance companies need one full year), and current year's holidays have to skipped before finding a mutually convenient date for the next appointment. Some times it can be 2-3 weeks away from the previous date, and can happen to be filed in the next month. This date has to marked as the page number with a pencil or an erasable pen in the right upper corner of the page. This new appointment date has to be noted in the 2nd year (2nd row) of the ‘PAP Smear Scheduling Date’ column. Once giving appointments, and filing the patient record in that corresponding date of that month is started, the original chronological order (serial order) can be disturbed. So it is a good idea to put a boldly visible dot next to the page number soon after an appointment is given. This differentiates from the pages that were not given appointments. The dot stays, until that month becomes current, and the patients list in that month is taken care of, and finally the month that the record is filed into, is concluded. As scheduling and marking page numbers are being done, it is a good idea to be simultaneously trying to restore serial order to the pages.

Even the new and moderately busy clinics would be able to call only a certain number of patients on any given day. So a tab can be used to mark the last page that was taken care of, whenever there is an interruption in the middle or at the end of the day, while calling the patients for appointments, so that it is easy to know where to start the next day. If the patient misses an appointment, the rescheduled date has to be marked as the new page number, and record filed where it belongs, without changing the dot. So it must have been understood by now, that a dot tells, that an appointment was taken care of, but the PAP screening is yet to be done.

The month and page number has to be noted down in the patient index, as soon as the page number is marked. As it was mentioned already the patient index has patients' names listed into different alphabetical pages. Suppose a patient's record is filed in ‘April’ and if the page number is 19, then it has to be noted in the patient index column as April 19 (month first—just like the way we write the date. It is easy to remember that way!). The patient index thus helps to locate the patient's record in the file.

If the filing from January-December is finished (i.e. finished filing, not necessarily scheduling!), that takes care of all the old patient pool from the lab's log book, who ever had Pap screening done in the clinic during the past year. These patients' names were also checked off from the computer-generated list, while the patient tables were being prepared. As it can be understood, while filing the patients from the lab's log book, if the same order is followed, the listing can be automatically filed in the right chronological order (or serial order) in any month of the file.

Past Due Non-Compliant Patients from the Computer List

Now, in the remaining names of the computer generated list, the female patients aged 18-6 (if age 65 is chosen by the clinic as the age to stop doing Pap smears) have to be identified, and their names underlined. These are the patients who are non-compliant (either last year only, or always), or being followed up elsewhere for PAP smear (which can not be known without calling them). This is the target population to be called. If the computer list also has the phone numbers, the charts don't need to be pulled. The patient can be called, and it can be found out if the patient is being followed up anywhere else. If they are being done else where, that information can be documented in the chart. A typed pro-format can be prepared to fill in the information about the patient's name, DOB and the date she informed that her PAP screening is done elsewhere, and that it was also indicated to her, that if she does not continue with the other place, it is her responsibility to call and schedule herself with the clinic for the subsequent PAP screening appointments. This filled in pro-format has to be kept in the health maintenance section of the patient's chart. Also a simple list can be made at the end of the file, of the patients' names that are being followed up else where. If the patient does not have the PAP smear anywhere, she needs to be asked if she likes to have it done. If she refuses, to avoid future litigations, a record can be created with only the patient's name, DOB, and phone number she was contacted at, and it can be documented that the patient refused appointment. This date when the non-compliance is confirmed, can be noted under ‘Scheduling Date’ column in the first row and (R) can be noted

next to that date. It has to done to all the patients who refuse appointments. However they can be tried again, around this date next year. Even these patients' records should be entered into the patient index, because it is the listing of each and every patient record that is there in the file. The date they are called and confirmed the non compliance, can be marked as the page number. Once taken care of, check off these patients' names from the computer generated list.

If patient agrees, a mutually convenient appointment date has to be given, and noted down in the ‘PAP Smear Scheduling Date’ column of the table, and the record has to be filed in that date. The patients picked up from the computer generated list can go to any month and to any date with in the month, depending upon the appointments they are given. However the existing filing is mostly in the chronological order (because to start with the filing from the lab's logbook was in the chronological order and it is still maintained that way with or without scheduled appointments after the filing). So when these records are filed into any month, it should be figured out where they belong. Filing these pages is not difficult at all. There are only few page numbers involved i.e. 1-31. So if the given appointment date is 20^{th}, it goes between the appointment dates (pages) 19^{th} and 21^{st}. Also putting a dot next to the page number should not be forgotten, so that it will be known that the appointment was taken care of. Make note that the patients' records from the lab's log book, filed in some of these months, may or may not given appointments, and hence may or may not have the dots next to their page numbers.

Because only certain number of patients from the computer list can be dealt with in any given time, it can be drawn over a period of few months, during which time the staff can be simultaneously taking care of current month's filing made from the lab's log book (i.e. previous year's patients' list). Also because the patients from the computer list are past due, it is a good idea to try to fit them into the current month's listing, if the clinic's appointment scheduling is not tight. If it is, it has to be found out from the patients when the previous PAP smear was done, and if it is more than 3 years ago, they have to be given the priority of scheduling. For patients whose PAP smears are done 1-3 years ago, and patients who had hysterectomies, their appointments can be spread over the next few months. And putting the dot next to the page number, should not be forgotten, so that it will be clear that the appointments of these patients are taken care of, when these months are being dealt with, at a latter date.

The second row of the ‘PAP smear scheduling date’ column can be used, to note down the scheduled appointment date. The first row has to left empty for the doctor to fill in any relevant past history (she could be an old patient with abnormal PAP smear which the doctor may find out after looking into her chart during the clinic visit, or after taking her history, for which there should be provision to document).

For these patients, their addresses in the screening tables can be filled in when they come for clinic visit. Their charts are going to be pulled on that day any way. If they don't come, no more time than necessary, is being wasted on a patient who is not going to continue as a patient of the clinic. So the work is trimmed down to a minimum, but still the filing can be functionally very efficient.

Random Visits, New Patients and Missed Appointments

The logging system should have an independent back up device to catch new patients, missed appointments and random visits.

To facilitate this, there should be some changes in the progress notes. On the top of the progress notes, a ‘Health Maintenance’ (HM) column has to be added, just like the columns for BP, pulse, wt. and other data. This column can be very simple like—

Health Maintenance - (Cancer screening)

| | |
|---|---|
| PAP Smear | January 2001 |
| Colorectal | |
| Breast | |

Gynecologists can have only PAP smear column (and mammogram column if they choose to).

Every time the patient is put into the room, the nurse should write in the space next to them, when these screening procedures were done last time (most of the time she only has to copy it from the previous progress notes). If the PAP smear is past due by 1 year, the nurse can talk to the patient about getting it done, and if the patient agrees, she can prepare the patient for PAP smear, so that every thing is ready by the time the doctor comes in. If the patient is undecided and has questions, the doctor can clarify. After the screening is done, the current date it is done can be added, next to the old date. For example—I showed 1/2001 in the health maintenance column above, and next to that, the current date can be noted, and during next clinic visit, only the new screening date can be documented. It can be mentioned also if the screening is done elsewhere, or if the patient refuses the screening. This also gives the opportunity to talk to the patient briefly during the next visit about any change in the situation. If there is no change in the situation, the nurse can mention as ‘no change’ (NC), so that the doctor can make a note of it. If this is a new patient, the patient's name has to added into the filing system. When a PAP smear is done, refused, or being followed up elsewhere, it has to be documented in the HM flow sheet of the chart. Some patients may not want to come in exactly one year later for a screening, but could come in for some clinical problem. From the health maintenance column added in the progress notes like this, it is easy to find these patients so that they can be talked to, and convinced, to have the screening done. It helps to give information handout to read before the doctor comes in to talk to the patient, which saves lot of time for the doctor. After PAP smear is done, if the doctor decides that the patient does not need the screening to be done every year, like those who had hysterectomy, the year can also be added underneath the date, noted in the right upper corner of the page in the filing (to be done for all the hysterectomy patients). Family practitioners can combine other screenings on the same day or choose to do it as an annual physical to cover other screening procedures also, if the patient happens to be age 50+. If she is less than that age, other screenings don't need to be mentioned in the column. In the beginning, this column can be written in the progress notes as I showed, but later it can get printed in the new progress notes

Duplication of patient listing in the file has to be avoided, whenever the noncompliant random visits, or even the regular clinic visits are being enrolled into the file (to enroll the regular clinic visit this way also should be tried). They might have been called already from the computer list, or their names have been entered from the lab's log book, into the file. To find out that, the patient index can be checked to see if the patient's name is entered. If not, it can be entered now, and then her name can be checked off from the computer listing or the lab's log book (it is easy to locate her in the lab's log book from the previous pap smear date found from her chart or the PAP smear table.). If her previous pap smear is within the past year, she is listed in the lab's log book. If the lab's and also the computer listing is completely taken care of by now, then all the patients are entered into the file. If she agrees to have the Pap smear done during this visit, the information can be documented in the Pap screening table, and the record filed in that current date, and month.

After the computer list is generated, new patients could have been added to the practice. They have to be identified and entered into the filing by paying attention to all the new charts that are encountered since the time the computer list is made. And as any body can understand, this has to be continued even after the lab's logging, and the computer listing, is completely taken care of, and from then on only the new patients are being entered into the logging system. The new patients can not be missed, as the nurse has to fill in the HM column in the progress notes. It is a good idea to high light this column for all the new patients, and document the relevant PAP screening data.

Tracking of the Patients

Tracking of patients for scheduling, and also tracking of patients for missed appointments every day, month and year is very easily and efficiently achieved in this system of filing. As mentioned already, unlike other files, the pages of the patient records in this file, don't stay in the same place all the time. They are designed to move to different pages (dates) and months, each time patient has a new appointment. In other words the records of the patients who have appointments on any day or month happen to stay in that month section with that day as their page numbers. So during any current month (and day) one is dealing with only that section of the month in the file. The records are also moving to the time period of the section when the next appointment is scheduled (or due), and serve as self-reminders of the scheduled appointment when that time period is current. So one has to only have to look into these pages on any current day, and know if the patients kept up the appointments or not. If not, they need to be rescheduled and their records move forwards into different dates or months and only patients (records) who kept up the appointments stay in the same page and they stay dormant until next year, when again this section has to be taken care of. Thus the file has built in tracking system, which the file implements itself without any extra efforts. Once the patient's screening is done, the dot has to be erased, and any patient's records left over with a dot marked, denote the patients who have missed appointments (at the end of the day), or refused appointments (at the end of the month). There should not be any dots in any page when the month is being concluded, to proceed to the next month.

It is also like a cyclic perpetual calendar of 12 months, with each page documenting 8 years data and having an expected life span of 7 years (the first row being meant for the past history) These pages are like calendar days of that month and on any particular day looking at them, you know who are coming that day so that you can very easily identify missed appointments on the same day, and call the patient immediately either to remind or reschedule. If your scheduling is not very tight, calling the same day would serve both the purposes.

More About Page Numbers of the Month and Subsequent Scheduling

For the patients logged into the file already (patients from the lab's log book), the appointments need to be scheduled. As already discussed, the current months were taken care of when the filing was just started, and these are the months that were not current at that time. It is a good idea to start one to two months earlier, for scheduling, for any given month. That way, it is easy for either side involved. It can be recollected, these pages are in chronological order and also dated. The previous PAP smear dates are only provisional appointment dates that need some corrections, which can be done after confirming the appointment date with the patient. As already mentioned, at least one day has to be added to the previous years date, current years holidays have to be skipped, and a mutually convenient appointment date has to be given for the patient. This has to be marked as the new page number, and it has to be noted in the 2^{nd} row of the scheduling column of the PAP smear information table. As mentioned before, a dot has to be marked next to the page numbers after the appointments are given. This simple technique has to be followed whenever appointments are given for patients during any month. Otherwise there will be mix up of patient appointments (with the ones that are not given appointments). The rearrangement of the month's file in chronological order as per the newly assigned page numbers is better done only after all the patients' appointments are taken care of, for that month. It may not be very feasible in the beginning when the file is still being made. But this rule can be best followed when the time comes to start scheduling the patients 1-2 months in advance. Using a pencil to mark page numbers makes the job easier. These new page numbers have to be noted in the patient index also. And these appointments have to be entered into the main appointment book, with the front receptionist. Attention has to be paid to the years noted in the right upper corner for the records of the patients who had hysterectomy, to make sure if they are due that year.

When the month becomes current, on any day, the staff knows who are the patients that are coming that day for the PAP smear. They can also know if they miss the appointment, so that they can be called immediately to be reminded or to be rescheduled. This rescheduled date can be noted in the PAP smears scheduling column, underneath the previous appointment date (the column has enough space for 3 dates). The page number also has to be changed to the new date to be filed in that date—either in the same month or the following month. It has to be noted in the patient index also. If it is not done each time the patient is given a new appointment, and the page number is changed, and the record filed into a different place, the patient's record not be identified on the same day of the appointment, but not on a subsequent day, if some body is looking for her record (unless the patient remembers the date of her previous appointment, but it seems very inefficient, if the clinic has to relay on the patient, to find her record in the file).

Make note there can be more than one of a particular page number or there can be some that are missing (holidays and weekends). After using the file for few years, the place where the page numbers are marked (on the right upper corner) may not be usable any more, in which case a photocopy can be made for future use.

When the patient's PAP smear is done, the date (month and year also) has to be documented in the second row, under ‘date PAP smear done’ (second column). There can be only ONE DATE in this column which happens to be, most of the times, the last date of the preceding ‘PAP smear scheduling’ column. If the patient does not keep up the appointment even after 3 dates, it can be written as ‘non compliant’ or missed appointment (M) in this column, and the patient's record stays in this page and month, i.e. the date of last missed appointment. The only choice is to try again around this time next year, or to catch her as random visit.

It has to be noted, there is no provision or need to write the MONTH or the YEAR on the top of any screening table page, nor there are any YEAR tabs in the file. However in the patients' screening table there is documentation of the months and years, along with the dates, for the appointments given, and the PAP smears done.

Pathology Reports

Refer to the ‘Abnormal reports’ table in the following pages (table—3). It is divided into 4 vertical columns meant for—patient's name and DOB, date of the abnormal report, exact description of the report as narrated in the pathology report, and the last column for the definitive treatment done and the follow up. Make note of the MONTH and YEAR on the top of the table.

I have mentioned that the previous year's PAP screening report has to be documented in the first row, if it was abnormal. It is the doctor's choice to document or not, if it is normal. The current year's pathology reports is documented, when it is back, in the 2nd row of this column. They can be entered as they are received, or it can done at one time, after all the reports are received. Abnormal reports have to be high lighted and the patients notified. And also, all the month's reports have to be clipped together, to be saved in the back of the file. After all of them are received, every month the doctor has to go through them and make sure the abnormal reports are entered correctly. It does not take lot of time. The doctor only has to quickly scan for any abnormal reports received from the pathology lab, and check if these are entered correctly into the file. He also has to sign under ‘Patient notified’ column for all abnormal reports. Same with the ‘Abnormal Reports’ section also. At the end of each month, he has to write ‘Reviewed’ and sign. He can request the staff to pull the charts of the abnormal reports, so that the treatment plan can be written, if it was not done already. From now on, for definitive treatment of any abnormal PAP screening and the further follow up, the ‘Abnormal reports’ section is the only place one has to refer to.

The above precaution of the doctor reviewing the reports every month is to avoid missing abnormal reports by misplaced charts from his office table that can cause surprises later. The PAP smear reports can be called, or cards can be mailed to—what ever worked in the past. A computer generated pro format can be made, for normal and abnormal reports notification. For abnormal reports, no need to mention anything in the letter for confidentiality purposes. The patient can be invited to call, or come in, for discussing about the recent PAP smear results. For these already printed pro-formats, one only needs to add patient's name on the top, and the word ‘normal’ for all normal PAP smear reports.

How to Conclude Each Month's Section

After all the pathology reports are back, entered and the doctor reviewed, it is time to conclude this month. The existing page numbers are also going to be future appointment dates for these patients. It is right to call as ‘Provisional’ appointment dates, because at least one day has to be added, the next year's ‘calendar correction’ has to be made, and also find a mutually convenient date closest to this date. All these can be best done, at one time next year, when scheduling these patients 1-2 months before due dates. So for now, no changes are made in the existing page numbers. How ever, it has to be made sure that there are no dots next to the page numbers at this time, because they have to be marked again next year during the appointments. Each year only one row or one horizontal column of this table is being used. After Pap smear is done, the record stays in that page (date), and in that month section, until next year around this time and month, at the time of the patient's next appointment, the third column is used to document the information as described before. So this is the typical way of working for any month of the file.

After the current month's PAP smears are done, the month's file stays dormant until next year, except some new additions can be added to the months patients' list like—

1. Abnormal PAP screening rescheduled for repeat PAP during any month, and the records filed into that month.

2. New clinic patients whose PAP smears are current, and not past due, and filed into the logging system, for future follow up of PAP smears, on that date.

3. New additions, that call in for appointment for this month.

When the month becomes current, random visits, missed appointments and new patients who have PAP screening done during the same visit, can be further added. Thus the file grows every year.

Documentation in the Patient Index

As soon as the patient is entered into the logging system, the record's ‘where—abouts’ should be documented in the patient index. I already mentioned how to put the month first and then the date (no year). When the patients' records from the lab's logbook were entered, they were filed into the months in the chronological order, marking the previous Pap smear date as the page number. Each time the patient's page number changes, it has to be documented in the patient index. This is the only way to find out where the patient's record is in the file at any given time. The date in the patient index has to be high lighted when patient misses an appointment. After the monthly appointments are confirmed and the file rearranged, these changes should be added to patient index also. So the last date listed in the patent index tells where the patient's record is located. It also tells, when the next appointment is, or when the most recent appointment was. Patients who refused appointments but entered into the logging system anyway, should also be entered into the patient index (these are the ones from the computer list). If not, these patient's record can not be found, if looked for during a random visit.

Whenever the columns are filled up for any patient's name, a new patient index page has to be added, filed adjacent to the existing page. It is enough to write only that patient's name in the new patient index sheet. The old patient index sheet may be retained, even after it is completely filled in, because it helps as a quick scan of the longitudinal record of the whole patient population.

Abnormal Reports

All the abnormal reports including the cervical, and endometrial biopsy reports, have to be documented exactly the way reported by the pathologist, in the abnormal reports section at the end of the file. The idea is to make sure that these patients are followed up until the definitive treatment is done. Once a patient's name is entered into, only this section can be referred to, for all the future follow up of the abnormal reports. Note the month and year at the top, for each list. The doctor has to sign at the end of each month after reviewing the list.

How to Change the Page

Each patient record has a life span of 7-8 years. After that, a fresh page has to be added. 1-2 months ahead of the due date, after calling and confirming the appointment, the scheduled appointment date can be noted in the ‘Pap smear scheduling’ column, in the second row of the new page started. Any abnormal pathology report in the past year has to be noted also. If there is any thing abnormal few years before and worth noting, it can be written in the back of the page, and a highlighted arrow drawn in the right sided space of the table can hint that there is information in the back of the page. So one may choose to write important past history in the first column, and also in the back of the page. The patient's personal data has to be filled in also in the top space of the table. Now the old page has to be saved in the ‘Saving file’.

[image]

Saving File

The saving file has to be started, 7 years after the file is originally started. Only things needed to make a saving file is—tabs A-Z, to file the corresponding alphabetical patient's records. In each alphabetical section, the patients' records are in serial order. The serial numbers can be marked on the top of the pages, and they are to be marked in chronological order, as the new records are added to the file. The corresponding serial number can be marked in the patient's new record, in the middle of the top space (the alphabet, followed by the serial no.)—for cross reference, if any information about these patient are needed in the future.

Misplaced Records

If a patient comes for an appointment and if her record is not found in that day or month section, the visit has to be treated like a new visit and a new record can be created. It is not time consuming at all. Her chart can also be checked to see if she had any abnormal reports in the past to check the ‘Abnormal Reports’ section, for any clue about the filing.

The date can be documented in the second row of ‘PAP Smear Done’ column after the PAP smear is done, if the past history is noted in the first row. No harm, or impairment in the future management of the patient's record or the file, is expected out of this accident. There can be a section for ‘Misplaced Records’ at the end of the file, and the patient's name can be noted in that section. If the patient's record is found in another place at a later date, it avoids confusion.

Missed Appointments

It is important to identify habitual missed appointments and non-compliant patients in any practice. Each patient record is a longitudinal record of eight years. Many scheduling dates in the first column, wide spaced dates in the second ‘PAP smear done’ column, indicates habitual non-compliance. As all the missed appointments in the patient index are high lighted, it serves as the longitudinal record of any individual patient, and also the whole patient population in general. These patients have to be discussed during staff meeting, and the doctor should contact them. Patient education, rest of family involvement (without compromising patient confidentiality) can help.

Other Additions

Additions like ‘To do List’ for any month, and ‘Issues to discuss during staff meeting’, and other sections as required by the individual needs of the clinic can be added to the file. Also ‘reminder notes’ with date (and also year), and the relevant information can be filed in any date to be exactly reminded on that date. There can be ‘Work Sheet’ for any month to be used as needed and desired. There is a printed ‘Work Sheet’ at the end of this text in the file compilation section, which is divided into two broad columns, meant for ‘patient names’ and the ‘relevant information’. It can be used as a work sheet for ‘patient scheduling’, or for ‘the notification of results’. The purpose it is being used for, can be rounded of, at any given time, but it is supposed to be used for both the purposes—i.e. when the patients are being scheduled or being called with the results, both of which can need more than one or two attempts.

The filing can also serve as a tracking system for ‘Annual physicals’ for all the adult female population in the practice, if the doctor chooses to do the annual physicals for all the patients.

An Alternative way to do Patient Index

Even if one or two patients in any alphabetical group are non compliant, and had repeated appointments, the patient index sheet can fill in fast, and a new patient index sheet has to be added, where only these patient's names are noted. If it is felt as rather cumbersome, another way to do it is, to use only one small column in the ‘location of patient’s records' part of the patient index, and erase the old appointment date (noted with a pencil, or an erasable pen), when the patient has a new appointment and a new page number. So there will be only one date, which tells where the patient's record is, or when the next appointment is. However the disadvantage is—there will not be any longitudinal record of any patient, or the whole patient population, to identify at a glance, the non compliant patients. But over a period of time, it may be realized that addition of pages can actually cause confusion, and noting only one date in this column has the advantage of having never have to add any patient index pages, even after 7-8 years, except for the sake of adding new patients to the file. For some patients, as the appointment can be changed many times, and the dates erased many times, the next available spaces can be used. The clinics that want to simplify their filing, can do this way of filing from the very beginning, and the habitually non compliant patients can be identified when their records are reviewed at the time of their appointments, and their names can be noted, so that the doctor can contact them at the end of the month.

Other Important Factors

Lots of clinics have ‘Health Maintenance’ flow sheets in their patients' charts, but in practicality everybody may realize it is hard to keep up with. The reason is, it is only the doctor, who is the busiest person in the clinic, who has to have to look into these issues, and decide to schedule the appointments. Depending upon the seriousness or severity of the problem the patient comes in for during any particular visit, these ‘Health Maintenance’ issues are overlooked, forgotten, or considered as the nature of lesser importance. How ever the good thing even in this frustrating issue is, that the screening and scheduling are to be done once a year, and there is no clinical data to look into, as a prerequisite for this scheduling, so that it does not need to be only the doctor who has to decide that it is time to schedule any patient for a screening. Much time can be wasted flipping through the pages of the chart during each patient visit to make sure that the patient's cancer screening is up to date. Still there is no guarantee that one can be worry free thinking that it is done as it should be, at all the times, and for all the patients. It is amazing how a clinical issue as simple, and as mechanical as yearly scheduling of cancer screenings, can consume so much time during each visit, and generate so much anxiety due to the awareness of our inefficiency of this monumental task. A filing system like this can completely relieve the primary care physician from that burden. We all agree that the rest of the staff members are happy to share the responsibilities to make the clinic more efficient. Teach them and let them be thorough with screening guidelines of all Health Maintenance protocols. Let them also participate in these responsibilities.

Similar filings are available for Prostate, Breast and Colorectal cancer screening (all three in one) and there is also filing and tracking system for childhood immunizations (both also written by me). All the patients should go through these files before being put into the room by the nurse. Let the nurse check if the patient had PAP smear, Colorectal cancer screening, mammogram or PSA done for that year, and if not prepare the patient for screening.

This filing can also serve as a tracking system for annual physicals for all adult female population, if the doctor chooses to do that in the clinic. The file can also be taken to the staff meetings to discuss about abnormal reports, and thus every body will be assured that abnormal reports are being followed up until definitive treatment is done.

The person that reads this, either the physician or the office manager—can instruct the whole staff how the file functions, during a staff meeting or lunch time. The staff needs to be monitored by the physician to see if they are doing the filing correctly, and more importantly to make sure they understand it. It's purpose is better served if everybody in the clinic that is involved with the filing, reads this material, and refers to it whenever they have questions. Once the whole patient pool is entered into the file in the first year, which is the difficult part, the maintenance during the subsequent years is unbelievably easy.

### CONCLUSION

Once this system of filing and tracking is understood practically after few days of using, it can be realized, that it is a very easy, yet very effective way of filing, scheduling and tracking of PAP screening and the system designed is an error proof, and an easy compliance system, with more than one independent and not interdependent built-in back up devices, that gives confidence and control, which also has legal implications of protecting against the possibility of a law suit for failed early detection.

[image]

[image]

[image]

[image]

[image]

[image]

[image]

[image]

[image]

[image]

[image]

[image]

[image]

[image]

[image]

1. A method of female genital cancer screening or Papanicolaou (Pap) screening system, for patients' clinic scheduling, filing, and tracking, written as an instructional manual, where in,
(a) there are initiative measures to file in the whole patient pool into the logging system,
(b) scheduling them again for screening, every year, even if they don't come by themselves, because of the built in, error proof tracking system, which implements itself, with out any extra effort,
(c) more than one independent and not interdependent back ups in the system, to catch up current missed appointments, and past refused appointments at the earliest opportunity, and also to enter the new patients into the logging system, on an ongoing basis,
(d) a simple manual filing system that suits both for rural and urban clinic set ups.

2. The method of Pap screening system of claim 1, comprising of 3 divisions as—
(1) patient Index—Comprising of tabulations of patients' names in an alphabetical order A-Z, and each table divided into 2 broad columns, the first column containing the patients' names and DOB (date of birth), and the second column ‘The location of the patients' records’, which is again divided into smaller columns, to note each and every appointment dates of the patients, that also happen to be the records' page numbers in the file, the last appointment date noted (also the page number), indicative of the current location of the patient's record,
(2) Pap screening information division—contains all the patients' records located in the 12 months sections January-December, marked by month tabs, each month containing the records of the patients who have most recent appointments in that month, each page of this section being allotted to one patient, the typical page comprising of ‘Pap screening information table’, that has patient's personal data (name, DOB, address, and phone numbers) on the top, and the actual table is divided into 8 horizontal rows to note 8 consecutive years' Pap smear information (thus giving the page a maximum life span of 7-8 years, after which the page can be replaced by a similar new page), and the above said table also has 4 vertical columns, that are made up of,
Pap smear scheduling dates—where in, the dates the patient has the Pap smear scheduled, is noted, which can contain more than 1 date in any horizontal row, meant for each year's information,
date Pap smear done—contains only one date in each horizontal row, i.e. the date the Pap smear is done, in any year,
pathology report—to mention the report briefly, and to highlight all the abnormal reports, which also have to be entered into the ‘abnormal reports’ section of the file,
results notified—to write if the PAP smear results were informed to the patients, and the abnormal reports to have the additional information like when and how the patient was informed, and should also be signed by the doctor.
and the above said Pap screening information section of each month has records of the patients, noted by page numbers 1-31 (that also happen to be the dates of the month), marked with a pencil or an erasable pen, in the right upper corner of the page, and these marked page numbers also happen to be the most recent or the future appointment dates of the patient, and when ever the appointment is changed, the page number is erased, new appointment date marked as the new page number, and the patient's record move to that date and month to be filed there, thus the procedure of this system is unique in that unlike other files, the pages of the patients' records of this file don't stay in the same place all the time, but rather move forwards in time when ever a new appointment is given, as it can be noted that the pages of each patient record does not contain the month or year, in the data noted in the top, though the table itself contain the day, month and the year when the Pap smears are scheduled and done, and so the patient's record is marked in it's location with the date as the page number, and the month by the month section (with the month tabs) it is located in—the devised model giving the file the nature of a perpetual calendar, the pages of which changes every 7-8 years,
(3) Abnormal reports—A section allotted for abnormal reports like ‘Ascus’, ‘cancer in situ’ or ‘invasive cancer’, the results being noted in a table every month and the month and year being mentioned in the top of the page and the page itself divided into 3 vertical columns, meant for—1. the patient's name and date of birth, (DOB), 2. PAP smear report—that has the detailed Pap smear report exactly as narrated by the pathologist's report and 3. definitive treatment done and follow up—which should also mention referral to the ob/gyn.,
and included at the end of the descriptive text of the Pap screening scheduling, filing, and tracking system, is the section for the components of the ‘file compilation’ that has instructions and the materials to be used, to construct the above described 3 components of the file—like the sectional headings, file dividers, tabs and tables, to be used in the file, and they are to be used as supplied, as they are made exactly as described in the text.

3. The method of Pap screening system of claim 2, which can be initiated, starting with the list of the patients who had Pap smears done in the clinic during the previous year, from the lab's log book (which is in the chronological order), for which the easy way to start is, to have the loose sheets of the ‘Pap screening information table’, and enter the patient's personal data on the top, and the date of the most recent Pap smear in the first horizontal row of the ‘the date pap smear done’ column, along with the abnormal reports, if any, to be entered in the ‘pathology report’ column of the same row.

4. The method of claim 3, the initiation of the Pap screening filing system from the previous year's Pap screening listing, which being not complete, a computer generated patient list in alphabetical order, with patient's age and phone numbers, should be simultaneously used, to include the whole patient pool.

5. The method of claim 3, where in, the patients' names, as they are being picked up from the lab's log book, these names have to be checked off from the computer generated list, which can be easily done, as this list being in alphabetical order.

6. The claim of 3, where in, the initiation of the file can be done, starting with the patients of the current month of the initiating of the filing, to be functionally effective from the beginning, and these patients have the current year's appointment again around the previous year's date, and after the patient's personal information data is entered, the date of the appointment has to be marked with a pencil or an erasable pen as the page number in the right upper corner of the page, to be filed in that month's section, the range of the page numbers in any month's section being 1-31, like the calendar pages of the month, and once the page number is marked, it should always be noted in the patient index under the column ‘location of the patients' records’ (the location being also the appointment date), with out which the patient's record can not be located in the file.

7. The method of claim 6, where in, during the initiation of the filing, the patients can be simultaneously called for the Pap smear appointment, at which time at least 1 day has to be added to the previous appointment date (which makes one full year to be covered by the insurance companies), current year's holidays need to be skipped, and a mutually convenient date has to be found, and the complete date can be noted in the column, ‘Pap smear scheduling date’, of the Pap screening table, and the day marked as the new page number in the right upper corner (the year also marked for patients who don't need screening every year, like the patients who had Hysterectomy), and the record filed in that particular month section, with a clearly visible pencil dot marked next to the page number, so that it can be differentiated from the pages that are not scheduled for appointments yet, and the dot stays until the month becomes current, the patients' list in that month is taken care of, and finally the month is concluded, except when the patient misses the appointment, and she has to be rescheduled and filed as per the new appointment date again, during which time the dot does not need to be erased, unless it is confirmed that the patient refused to have the Pap screening done, at least for that year or indefinitely, in which case the only thing that can be done is to try again next year around that time of appointment, and during the time when the new appointment dates are given, and the records filed accordingly, the dates have to be noted in the patient index also simultaneously, and the way to mark it is, to write month first, and then the day, just like the way a date is written on a regular basis.

8. The method of Pap screening system, where in, the non compliant and missing patients from the lab's previous year's list, can be identified by,
1. checking off the patients' names from the computer generated list, as the patient's records are made from the lab's logging system,
2. identifying female patients aged 18-65 (if the clinic chooses age 65 as the time to stop doing Pap smears), in the remaining names of the computer generated list, and under lining these names, these patients either being noncompliant, or being followed up else where, which can only be found out by calling these patients, and if they are not being followed up any where, they are offered mutually convenient appointments.

9. The method of identifying and scheduling the non compliant patients as of claim 8, where in, the preference of the early appointments are being given to patients who never had Pap smears done in the past 3 years, and the others with screening 1-2 years past due, being spread over the next few months (if the clinic happens to be very busy), and these appointment dates being also documented in the second row of the ‘Pap smear scheduling dates’ column, the first row being left empty, for the doctor to fill in the relevant past history, and these appointment dates being also marked as page numbers with dots, and filed in the serial order in the corresponding month section, all the while the dates are also being noted in the patient index, and these patients' personal data filled in on the top of the Pap screening table, when they actually keep up the appointments, at which time their charts are pulled.

10. The method of Pap smear logging system, where in, there is a back up device to catch new patients, missed appointments, and random visits—which can be done by creating a ‘Health maintenance’ column in the top of the progress notes along with the rest of data, like BP, pulse, wt. etc., where in all the screenings like Pap screening, and the breast and Colorectal cancer screenings have columns, against which the dates when last done, can be written by the nurse, when the patient is first put into the room, during which time, if they are past due, they can also be prepared for cancer screening before the doctor comes in, and if the screening is done during that visit, the new date can be noted next to the previous date in that column, and in the following visit only the new screening date can be written, and doing this extra task during each visit is not difficult, as the nurse only has to check the previous progress notes to get that information for all the old patients.

11. A method of Pap screening system, in which the new patients after the computer generated patient list is printed can be identified, by paying attention to all the new charts and new patients that visited the clinic since the time the computer list is made, and they can also be entered into the filing system in the way already described—either having Pap smear done during that visit, if it is due or past due, or being just filed in, to be called subsequently when the date is due, and these new patients can not be missed because of the routine of the health maintenance column being included in the progress notes, and needs to be high lighted for all the new patients.

12. The method of Pap screening scheduling, filing and tracking system as of claim 1, where in, the tracking of the missed appointments every day and month, is being done by dealing with only the patient records of the current date and month, to find who missed the appointments—this being achieved by erasing the dot next to the page number, after the screening is done for any patient, and the patient records left over with a dot, denoting the missed appointments (at the end of the day), or refused appointments (at the end of the month), and when the month is concluded, none of the patient records in any month should have the dots next to the page numbers, even for the refused screenings until the next year, when they have reappointments again.

13. The method of Pap screening filing system in which the duplication of the patients names in the file is avoided, while logging in the missed, random and new visits by checking into the patient index to see if the patient is already entered into the system, and if not, she can be entered, and her name can be checked off from the labs log book, or the computer list, and if the recent Pap smear was done with in an year, her name can be found in the previous year's list from the lab's log book).

14. The method of claim 12, where in, the tracking of the patients is being implemented by the file itself, by the virtue of the way it is devised, with out any extra efforts, and unlike any other files, the pages of the patients records of this file do not stay in the same place all the time, but move to different pages (dates) and months, each time the patient is given an appointment, and during any current month (and day), one is dealing only with that section of the month in the file with their records as the self reminders of the appointments, enabling the tracking very simple and efficient.

15. The method of the Pap smear filing system, where in, the current month's scheduling is taken care of when the file is initiated, but the subsequent month's filing when the time comes, can be called in 1-2 months in advance for appointments, during which time, at least one day is added to the previous appointment date, holidays skipped, and a mutually convenient appointment date is given, which is remarked as the page number with a dot, and the date documented in the ‘Pap smear scheduling dates ’ column, and also noted in the patient index.

16. The claim of 15, where in, the dotting of the page numbers prevent the mix up of the patients' records with and without appointments, and the rearrangement of the month's file in the right serial order, as per the newly assigned page numbers, can be best done after all the appointments are taken care of, for that month.

17. While doing the appointment scheduling ‘the work sheet for the month’ can be used to note down the patients' names who may need to be called more than once, and the same type of work sheet can be used when the patients are called to inform the Pap smear results also.

18. The method of Pap smear filing system where in, the page number and the dots next to them are marked with a pencil or an erasable pen, and when ever necessary a photocopy of the page can be made, so that it is not hard to use any page for 7-8 years.

19. The method of the Pap smear filing system, where in, all the abnormal pathology reports are entered into the ‘Abnormal reports section’ of the file, into a table that is divided into 4 vertical columns meant for 1. patient's name & DOB, 2. date of abnormal report, 3. abnormal report (the exact description of the report as narrated in the pathology report), and the last column 4. the definitive treatment done and follow up; and the doctor at the end of each month should review the whole month's reports saved as a clipping in the file, making sure that the abnormal reports are correctly noted in the Pap screening table, and entered into the abnormal reports section of the file (and signed to that effect by the doctor), and during that time, the definitive treatment should also be taken care of, if not done already, along with the documentation in the chart, all these precautions safeguarding against missing abnormal reports by misplaced charts from the doctor's office table, and finally, before concluding the month, making sure that all the patients are notified either by a phone call, or by mailing cards, inviting them to discuss about the abnormal reports.

20. The method of Pap smear filing system, where in, after all the abnormal reports are taken care of, the month has to be concluded, and the page numbers which are the ‘provisional appointment dates’ are left as they are, making sure there are no dots on any page numbers, until the rescheduling next year, during which time at least one day has to be added to the provisional appointment date, the year's holidays skipped, and a mutually convenient date has to be scheduled and marked as the new page number with a dot, and each year, one horizontal row of the Pap screening table is used to document the data.

21. The method of Pap screening system, where in, all the new appointments, as soon as they are scheduled, the day is marked as the page number, and the appointment (day and month) entered into the ‘location of the patient's records’ column of the patient index, and it can be done in two ways as,
1. having only one column in the ‘location of the patient records’ part of the patient index, and erase the old appointment date marked with a pencil, and note the reappointment each and every time, so that there is only one date at any time in this column, that tells where the patient's record is (or when the most recent appointment is), this method being simple and less confusing,
2. having 10-12 small columns in the broad vertical ‘location of the patients' records’ column of the patient index, and document the dates each and every time the patient is given an appointment.

22. The method of Pap screening system, where in after 7 years, a new Pap screening information table has to be added, and the old records saved in the saving file, made up of alphabetical sections A-Z, and the records are filed in each section in chronological order, noting serial numbers in the center of the top of the page as they are added into the file, and the corresponding serial number (alphabet, followed by serial no.), can also be noted in the top corner of the new page, for future cross reference, for any needed information.

23. The method of Pap smear filing system where in, a new record can be created, when a patient comes in for an appointment, but her record is missing from the right place due to incorrect filing during the previous appointment—this type of accident not causing any impairment of the functional integrity of the individual patient record, or the file as a whole, and there can be a section for the misplaced records at the end of the file, where the names of the patients with the missing records can be noted, which can avoid confusion, if they are found in unexpected places subsequently.

24. The method of Pap smear filing system, where in, additions like ‘to do list’, ‘issues to discuss during staff meeting’ and other similar sections can be added to the file at the end, and there can also be ‘reminder notes’ with date (and also year), with what ever relevant information written, that can be filed with that page number, to be exactly reminded on that date, month and year, when it becomes current.

25. The method of Pap screening system, which is supplied with a section of ‘the file compilation’, soon after the description of the text, which is comprised of the instructions, and materials to be used, to actually construct the file—like sectional headings, tabs and tables, the photocopies of these tables being used in all the three sections of the file i.e. the patient index, Pap screening information and the abnormal reports.
